(19) United States
(12) Patent Application Publication
(10) Pub. No.: US 2008/0100866 A1
(43) Pub. Date: May 1, 2008

(54) Image Forming Apparatus and Image Forming System

(75) Inventor: Akihiro YAMADA, Nagoya-shi (JP)

Correspondence Address: BANNER & WITCOFF, LTD.;ATTORNEYS FOR CLIENT NOS. 0166889, 006760, 1100 13th STREET, N.W., SUITE 1200, WASHINGTON, DC, 20005-4051, US

(73) Assignee: BROTHER KOGYO KABUSHIKI KAISHA, Nagoya-shi (JP)

(21) Appl. No.: 11/933,620

(22) Filed: Nov. 1, 2007

(30) Foreign Application Priority Data
Nov. 1, 2006 (JP) 2006-297973

(51) Int. Cl. G06F 3/12

(52) U.S. Cl. 358/1.15

(57) ABSTRACT

An image forming apparatus is described. The image forming apparatus may be connectable to a network and provided with the number of printable sheets set for each user, including: a determination unit determining whether or not there is a print instruction exceeding the number of printable sheets set for the user; a retrieval unit retrieving an image forming apparatus available for the user from among other image forming apparatuses connected to the network when the determination unit determines that there is the print instruction exceeding the number of printable sheets set for the user; and a data output unit outputting data of an image which should have been printed on the basis of the print instruction from the user when the retrieval unit detects any image forming apparatus available for the user.

### CROSS REFERENCE TO RELATED APPLICATION

This application claims priority to Japanese Patent Application No. 2006-297973 filed on Nov. 1, 2006, the disclosure of which is hereby incorporated into the present application by reference.

### TECHNICAL FIELD

The present invention relates to an image forming apparatus having a function for controlling the number of printed sheets, and an image forming system including this image forming apparatus.

### BACKGROUND

For an office or the like, there is proposed an image forming apparatus having the so-called department control function for the number of copies, for preventing excess copying when a reserved number of copies set for copying exceeds the number of copiable sheets per department.

When the reserved number of copies exceeds the number of copiable sheets controlled by the department control function per department, this image forming apparatus displays a warning about this excess. After making copies by the number of copiable sheets, the image forming apparatus discards excess image data.

Due to this department control function, the image forming apparatus can prevent copying in excess of the number of copiable sheets previously allocated to each department, whereby the expenses can be saved in each department, and the user can be prompted to refrain from unnecessary copying.

If absolutely necessary image data are discarded when the reserved number of copies exceeds the number of copiable sheets, however, the image forming apparatus is not user-friendly. While such discard of the image data may conceivably be prevented by using both surfaces of each copying sheet (the so-called DX (duplex) printing) or by copying image data for a plurality of sheets on a single surface of each sheet in a reduced size (the so-called N-in-1 printing), to thereby copy all image data within the number of copiable sheets, this may not be desirable for the user.

### SUMMARY

One aspect of the present invention may provide an image forming apparatus capable of preventing discard of image data exceeding the number of printable sheets set for each user while maintaining an effect of a department control function, and an image forming system including this image forming apparatus.

The same or different aspect of the present invention may provide an image forming apparatus connectable to a network and provided with the number of printable sheets set for each user, including: a determination unit determining whether or not there is a print instruction exceeding the number of printable sheets set for the user; a retrieval unit retrieving an image forming apparatus available for the user from among other image forming apparatuses connected to the network when the determination unit determines that there is the print instruction exceeding the number of printable sheets set for the user; and a data output unit outputting data of an image which should have been printed on the basis of the print instruction from the user when the retrieval unit detects any image forming apparatus available for the user.

One or more aspects of the present invention provide an image forming apparatus connectable to a network and provided with the number of printable sheets set for each user, including: a printed sheet counter unit counting the number of sheets printed on the basis of a print instruction from the user: a retrieval unit retrieving an image forming apparatus available for the user from among other image forming apparatuses connected to the network after a count of the printed sheet counter unit reaches the number of printable sheets set for the user when the print instruction from the user is received; and a data output unit outputting data of an image which should have been printed on the basis of the print instruction from the user when the retrieval unit detects any image forming apparatus available for the user.

One or more aspects of the present invention provide an image forming system constructed by connecting to a network a plurality of image forming apparatuses each provided with the number of printable sheets set for each user, wherein each of the image forming apparatuses includes: a determination unit determining whether or not there is a print instruction exceeding the number of printable sheets set for the user; a retrieval unit retrieving an image forming apparatus available for the user from among other image forming apparatuses connected to the network when the determination unit determines that there is the print instruction exceeding the number of printable sheets set for the user; a transfer unit transferring data of an image which should have been printed on the basis of the print instruction from the user when the retrieval unit detects any image forming apparatus available for the user, to the image forming apparatus detected by the retrieval unit; and a printable sheet number update unit subtracting the number of printed sheets from the number of printable sheets set for the user when receiving the data of the image from the other image forming apparatus and forming the image which should have been printed on the basis of the print instruction from the user.

### BRIEF DESCRIPTION OF THE DRAWINGS

FIG. 1 is a block diagram showing the structure of an image forming system including complex machines as an example of an image forming apparatus of one or more aspects of the present invention.

FIG. 2 illustrates an example of a table stored in an EEPROM.

FIG. 3 is a flow chart showing processing related to a department control function.

FIG. 4 illustrates a table according to a modification.

### DETAILED DESCRIPTION

Embodiments of the present invention are now described with reference to the drawings.

### First Embodiment

### 1. Structure of Embodiment

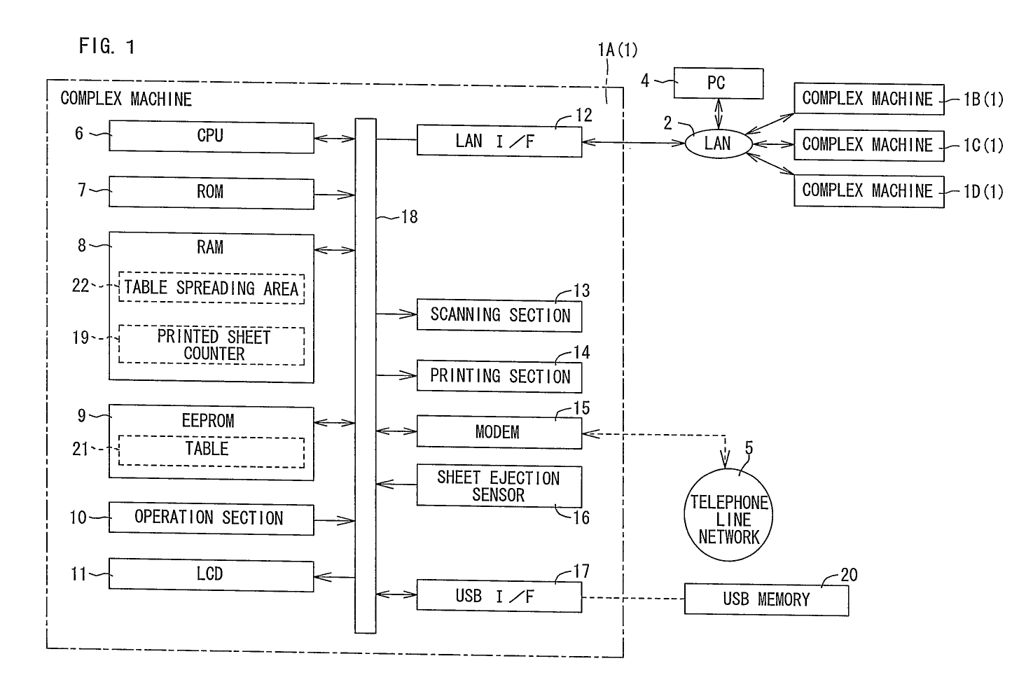

FIG. 1 is a block diagram showing the structure of an image forming system including complex machines as an example of an image forming apparatus of one or more aspects of the present invention.

This image forming system includes a plurality of complex machines 1 connected to a LAN (local area network) 2 as an example of a network constructed in an office or the like. A personal computer (hereinafter referred to as “PC”) 4 for transmitting image data and an image formation (printing) command to each complex machine 1 and making the complex machine 1 execute print processing is connected to the LAN 2.

Each complex machine 1 has a printing function for outputting an image based on image data received from the PC 4 to each sheet, a copying function for reading a document image and reproducing the document image on the sheet, and a facsimile function for reading the document image and transmitting the data of the read document image to the exterior through a telephone line network 5 and for outputting an image based on image data transmitted from the exterior through the telephone line network 5 to the sheet.

In order to implement these functions, the complex machine 1 includes a LAN I/F (interface) 12 for connecting the complex machine 1 with the LAN 2, a scanning section 13 optically reading the document image, a printing section 14 outputting the image data to the sheet, a modem 15 for connecting the complex machine 1 with the telephone line network 5, and a sheet ejection sensor 16 outputting a pulse signal (detection signal) in response to ejection of each sheet printed in the printing section 14, as well as a CPU 6, a ROM 7, a RAM 8 and an EEPROM 9 for controlling these components. The CPU 6 functions as a determination unit, a retrieval unit, a data output unit, a transfer unit and a printable sheet number update unit.

The LAN I/F 12, the scanning section 13, the printing section 14, the modem 15, the sheet ejection sensor 16, the CPU 6, the ROM 7, the RAM 8 and the EEPROM 9 are connected with one another through a bus line 18, so as to be capable of transmitting/receiving data to/from one another.

The ROM 7 stores various control programs etc. executed by the CPU 6.

The RAM 8 as an example of a printed sheet counter unit is used as a work area for temporarily storing data, a program and the like when the CPU 6 executes any of the control programs. For example, a printed sheet counter 19 for counting the number of sheets whose ejection has been detected by the sheet ejection sensor 16 (number of sheets subjected to image formation in the printing section 14), a table spreading area 22 for spreading data of a table 21 described later and temporarily holding the same and the like are set in this RAM 8.

The EEPROM 9 stores the table 21 described later.

An operation section 10 as an example of a setting unit including operation keys etc. operated by the user and an LCD 11 as an example of an information unit displaying information such as the operating situation of the complex machine 1 are connected to the bus line 18.

The complex machine 1 further includes a USB port (not shown) as an example of a connection port for connecting a USB memory 20 as an example of a storage medium to the complex machine 1. The complex machine 1 also includes a USB I/F 17 for connecting the USB memory 20 inserted into the USB port and the bus line 18 with each other. The USB I/F 17 and the aforementioned LAN I/F 12 function as data input sections.

The complex machine 1 has a so-called department control function. The department control function is a function for controlling the number of sheets subjected to image formation (printing) in the complex machine 1 per user (department) in an office or the like and preventing the user from excessive printing when the number of printed sheets exceeds a prescribed limit number.

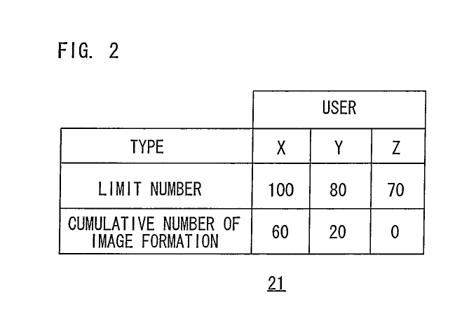

FIG. 2 illustrates an example of the table 21 stored in the EEPROM 9.

As shown in FIG. 2, a number (limit number) of sheets image-formable (printable) in the complex machine 1 (the complex machine 1 having the EEPROM 9 storing the table 21 shown in FIG. 2 is hereinafter referred to as “complex machine 1A” for the convenience of illustration) is allocated to each user in the table 21. In other words, the limit numbers for users X, Y and Z are set to 100, 80 and 70 respectively.

Thus, the limit number of sheets printable in the complex machine 1A is set per user, in consideration of the fact that the frequency of use of the complex machine 1A varies with the user. Other complex machines 1 (the complex machines 1 connected to the LAN 2 in addition to the complex machine 1A are hereinafter referred to as “complex machines 1B, 1C and 1D” respectively for the convenience of illustration) also have such tables 21, while the respective limit numbers set in the complex machines 1A, 1B, 1C and 1D for the same user are not necessarily identical to one another. This is because the frequencies of use by the same user vary with the complex machines 1.

The table 21 stores a cumulative number (cumulative number of image formation) of sheets image-formed (printed) by each user in the complex machine 1A in association with each limit number. When the user X executes printing on 60 sheets in the complex machine 1A, for example, the table 21 stores the number 60 as the cumulative number of image formation in association with the limit number 100 for the user X.

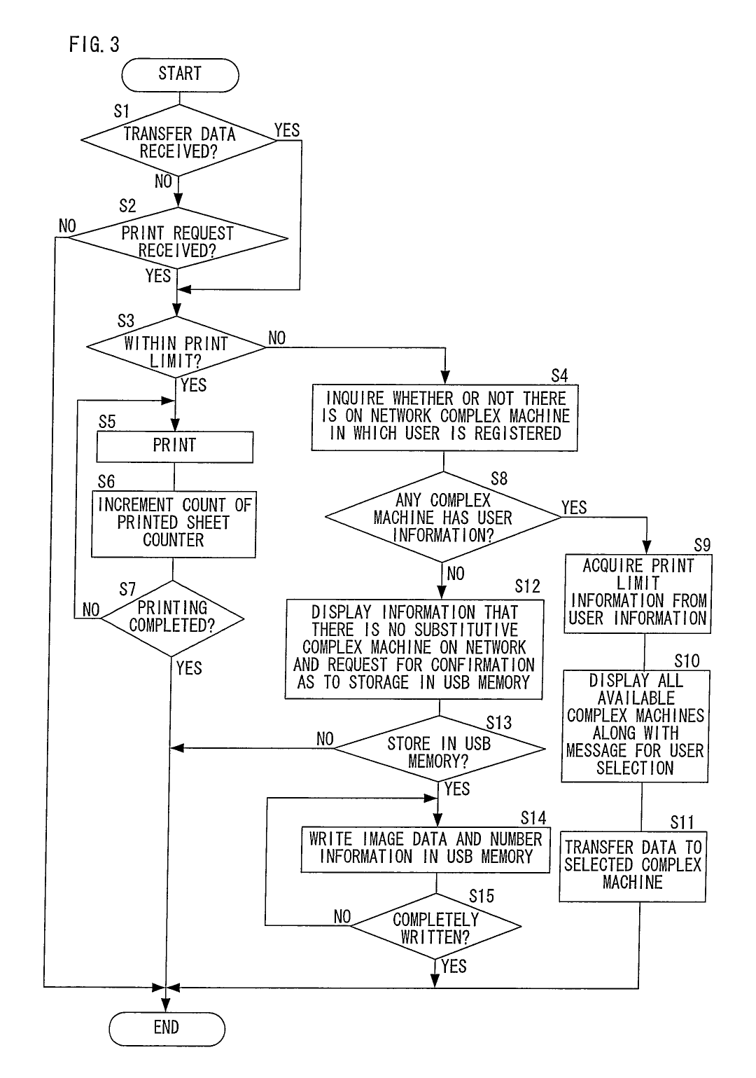

FIG. 3 is a flow chart showing processing related to the department control function. This processing is now described with reference to the complex machine 1A.

The CPU 6 of the complex machine 1A first confirms whether or not image data has been transferred from any other complex machine 1B, 1C or 1D (S1).

When no image data (transfer data) has been transferred from the other complex machine 1B, 1C or 1D (NO at S1) and the user operates the operation section 10 for inputting an instruction for image formation (hereinafter referred to also as printing) in the printing section 14, the CPU 6 determines that a print request (input of the instruction for image formation) is received (YES at S2). Alternatively, the print request (instruction command for image formation) may be input from the PC 4 along with the image data through the LAN 2. The following processing is not performed until the print request is received.

When the print request is received, the CPU 6 determines whether or not the print request is within a print limit (S3). More specifically, the CPU 6 moves the table 21 stored in the EEPROM 9 to the table spreading area 22 (see FIG. 1) of the RAM 8, and spreads the data of the table 21 in the table spreading area 22. Then, in the spread table 21, the CPU 6 refers to the limit number and the cumulative number of image formation for the user (see FIG. 2) in the complex machine 1A and the count of the printed sheet counter 19, and determines that the print request is within the print limit if the sum of the cumulative number of image formation and the count of the printed sheet counter 19 is less than the limit number (YES at S3). If the sum of the cumulative number of image formation and the count of the printed sheet counter 19 reaches the limit number, on the other hand, the CPU 6 determines that the print request is not within the print limit (NO at S3).

If image data (transfer data) has been transferred from any other complex machine 1B, 1C or 1D (YES at S1), on the other hand, the LAN I/F 12 inputs the image data from the other complex machine 1B, 1C or 1D in the complex machine 1A through the LAN 2. Alternatively, the USB memory 20 storing image data may be connected to the USB I/F 17 of the complex machine 1A, so that the image data is input by the USB I/F 17 without through the LAN 2. The input image data includes number information (information as to the number of sheets necessary for printing this image data), and the printed sheet counter 19 generates the aforementioned count from this number information, while the CPU 6 determines whether or not the print request is within the print limit on the basis of this count through the aforementioned procedure (S3).

If the print request is within the print limit, the CPU 6 makes the printing section 14 execute image formation (printing) on the basis of the image data (S5).

The sheet ejection sensor 16 outputs the pulse signal every time a sheet printed in the printing section 14 is ejected. The CPU 6 increments (+1) the count of the printed sheet counter 19 provided in the RAM 8 in response to the pulse signal output from the sheet ejection sensor 16 (S6). The count of the printed sheet counter 19 has been reset to zero before this processing has been started.

Thereafter the CPU 6 determines whether or not printing is completed, i.e., all sheets to be printed are completely printed (S7). If printing is not yet completed, the CPU 6 returns to the step S3, and re-executes the processing at the steps S5 and S6 if the print request is within the print limit.

When printing is completed (YES at S7), the CPU 6 adds the count of the printed sheet counter 19 to the cumulative number of image formation held in the table spreading area 22, and holds the obtained sum in the table spreading area 22 as a new cumulative number of image formation. Then, the CPU 6 rewrites the table 21 stored in the EEPROM 9 on the basis of the updated data held in the table spreading area 22.

If the sum of the cumulative number of image formation and the count of the printed sheet counter 19 reaches the limit number and the print request is not within the print limit (NO at S3), on the other hand, the CPU 6 checks whether or not other complex machines 1B, 1C and 1D connected to the LAN 2 include that having a limit number allocated to the user (S4). More specifically, the CPU 6 of the complex machine 1A accesses the tables 21 of other complex machines 1B, 1C and 1D on the LAN 2, and confirms whether or not limit numbers are allocated to the user, i.e., whether or not the user is registered in the complex machines 1B, 1C and 1D.

If there is any other complex machine 1 having the limit number allocated to the user, i.e., having information on the user (YES at S8), the CPU 6 acquires the limit number allocated to the user in the table 21 of all the other complex machines 1 having the information of the user, as print limit information (S9).

Then, the CPU 6 displays the other complex machines 1 having the information of the user, i.e., all complex machines 1 available for the user among the complex machines 1B, 1C and 1D, on the LCD 11 of the complex machine 1A, along with a request for selecting one of the displayed complex machines 1 (S10).

When the user operates the operation section 10 of the complex machine 1A and selects the complex machine 1 to be used from among the complex machines 1 displayed on the LCD 11, the CPU 6 transfers the image data to the selected complex machine 1 in a state where the image data is spread into bitmap data (S11). The complex machine 1 receiving the transferred image data makes a positive determination as to the transfer data at the step S1, and executes the processing at the step S3 and subsequent to the step S3.

The image data may alternatively be transferred in the state of not yet being spread into the bitmap data, along with the number information as to the number necessary for printing the image data.

If there is no other complex machine 1 having the information of the user on the LAN 2 (NO at S8), on the other hand, the CPU 6 displays on the LCD 11 this information, i.e., the information that there is no other complex machine 1 substitutive for the complex machine 1A on the LAN 2 and the information that the user is requested to select whether or not to make the USB memory 20 store the image data having been scheduled for printing in the complex machine 1A (S12).

When the user operates the operation section 10 of the complex machine 1A and selects the storage of the image data in the USB memory 20 (YES at S13), the CPU 6 writes in the USB memory 20 the image data in the state of being spread into the bitmap data, or in the state of not yet being spread into bitmap data along with the number information (S14). If the image data and the number information are completely written in the USB memory 20 (YES at S15), the CPU 6 terminates this series processing.

If the user selects nonstorage of the image data in the USB memory (NO at S13), on the other hand, the CPU 6 discards the image data and thereafter terminates this series processing.

If the print request is not within the limit number in the complex machine 1A (NO at S3), the LCD 11 may display a screen for prompting the user to select whether or not to retrieve any other complex machines 1 having the information of the user and to select whether or not to make the USB memory 20 store the image data having been scheduled for printing in the complex machine 1A. When the user selects the retrieval of the other complex machines 1, the process advances to the step S4, and the CPU 6 performs the processing at the step S4 and subsequent to the step S4. If the user selects the storage of the image data in the USB memory 20, the process skips to the step S14, and the CPU 6 performs the processing at the step S14 and subsequent to the step S14. If the user makes neither selection, the CPU 6 discards the image data and terminates this series processing.

### 2. Functions and Effects of First Embodiment

As hereinabove described, the complex machines 1 constituting this image forming system are interconnected by the LAN 2. In each complex machine 1, the number (limit number) of printable sheets is set per user. Each complex machine 1 counts the number (number of printed sheets) of sheets printed on the basis of the print request (print instruction) from the user. For example, when the CPU 6 determines that there is a print instruction exceeding the limit number for this user, i.e., after the print number (more specifically, the cumulative number of image formation) reaches the limit number for the user in the complex machine 1A, the complex machine 1 available for this user is retrieved from among other complex machines 1B, 1C and 1D connected to the LAN 2. If the complex machine 1 available for the user is found and usage of this complex machine 1 is instructed, the data of the excess image which should have been printed on sheets on the basis of the print instruction from the user is transmitted to the found complex machine 1. This complex machine 1 receiving the transferred data prints the received image data on sheets. After this image formation, the complex machine 1 subtracts the number of the printed sheets from the limit number set for the user.

If the CPU 6 determines that there is a print instruction exceeding the limit number for the user in the complex machine 1A, even when the number for printing set by the user reaches the limit number set for this user, for example, the data of the excess image can be continuously printed by utilizing the limit number set for the user in another complex machine 1 connected to the LAN 2.

Thus, the data of the excess image can be prevented from being discarded without being printed.

The excess image is printed in a complex machine 1 other than the complex machine 1A using the limit number set for the user in the other complex machine 1, and the limit number set for the user in the complex machine 1A is not raised in response to the excess image. In other words, the sum of the limit numbers set for the user in the complex machines 1 connected to the LAN 2, i.e., the total limit number set for the user in the whole image forming system remains constant. The limit number set for the user in the other complex machines 1 is utilized so that printing exceeding the limit number set for the user in the complex machine 1A is continuously executed in the image forming system. Therefore, the user is prevented from printing in excess of the total limit number set in the image forming system, whereby the expenses can be saved in each department in an office or the like, and the user can be prompted to refrain from unnecessary printing.

The number of sheets printed for the excess image in the other complex machine 1 is subtracted from the limit number set for the user in this complex machine 1, whereby the limit number set for the user in this complex machine 1 is correctly controlled.

The LAN I/F 12 in each complex machine 1 receives image data output from any other complex machine 1 connected to the network, and the printed sheet counter 19 in the RAM 8 also counts the number of sheets printed on the basis of this image data. Therefore, the number of printed sheets can be correctly controlled regardless of the print instruction from the user and the image data from another complex machine 1.

Each complex machine 1 includes the USB I/F 17 to which the USB memory 20 is connectable. Even if the print number based on the print instruction from the user reaches the limit number set for this user in the complex machine 1, therefore, the data of the excess image can be output to the USB memory 20. This USB memory 20 is connected to the USB I/F 17 of the other complex machine 1B, 1C or 1D, so that the USB I/F 17 inputs the image data in the other complex machine 1 similarly to the aforementioned LAN I/F 12 and the other complex machine 1 can continuously print the excess image.

The complex machine 1 outputs (transfers) to another complex machine 1 or the USB memory 20 the image data in the state of being spread into the bitmap data, or in the state of not yet being spread into the bitmap data along with the number information. Therefore, the complex machine 1 receiving the transferred image data or the complex machine 1 to which the USB memory 20 holding the image data is connected can easily grasp the number of sheets to be printed, and can correctly determine whether or not the excess image can be printed using the limit number set for the user.

If the print number reaches the limit number set for the user in the complex machine 1A and the complex machine 1 available for the user is found from among the other complex machines 1B, 1C and 1D connected to the LAN 2, the LCD 11 displays the information of the found complex machine 1. Thus, the user can easily grasp with which one of the complex machines 1 connected to the LAN 2 the excess image can be printed.

If the CPU 6 finds a plurality of complex machines 1 available for the user, the user can arbitrarily select on which one of the complex machines 1 connected to the LAN 2 the excess image is to be printed, by operating the operation section 10.

### Second Embodiment

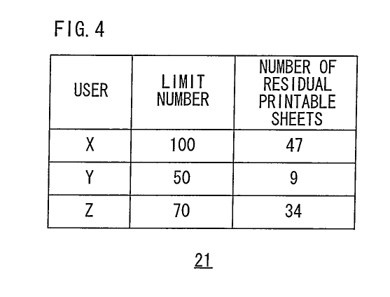

FIG. 4 shows a table 21 according to a modification.

At the aforementioned step S7, for example, the CPU 6 rewrites in the table 21 the value (the so-called counted-up value) obtained by adding the count of the printed sheet counter 19 to the cumulative number of image formation as a new cumulative number of image formation without rewriting the limit number, whereby a value obtained by subtracting the cumulative number of image formation from the limit number corresponds to the number of printable sheets for the next printing. Alternatively, a value (the so-called counted-down value) obtained by subtracting the count of the printed sheet counter 19 from the limit number may be rewritten as the new limit number. In other words, if the limit number is decremented every time the printed sheet counter 19 counts the number of printed sheets during printing, the updated limit number corresponds to the number of printable sheets. In this case, the table 21 may not store the cumulative number of image formation.

More specifically, the table 21 according to the modification stores for each of the users X, Y and Z a limit number and a number of residual printable sheets obtained by subtracting the count of the printed sheet counter 19 from the limit number. For example, the limit number for the user X is 100, while the number of residual printable sheets is 47. Thus, it is understood that the user X has printed 53 sheets in the complex machine 1 having this table 21. Similarly, the limit number and the number of residual printable sheets for the user Y are 50 and 9 respectively while those for the user Z are 70 and 34 respectively, whereby it is understood that the users Y and Z have printed 41 and 36 sheets respectively.

If the user X continues printing in this complex machine 1, the number of residual printable sheets is decremented from 47. If the number of residual printable sheets reaches zero, the excess image is printed in another complex machine 1 in which the number of residual printable sheets allocated to the user X is greater than zero. In this table 21, the numbers of residual printable sheets are important, while the limit numbers themselves may be omitted since the same are stored merely as standard values.

The embodiments described above are illustrative and explanatory of the invention. The foregoing disclosure is not intended to be precisely followed to limit the present invention. In light of the foregoing description, various modifications and alterations may be made by embodying the invention. The embodiments are selected and described for explaining the essentials and practical application schemes of the present invention which allow those skilled in the art to utilize the present invention in various embodiments and various alterations suitable for anticipated specific use. The scope of the present invention is to be defined by the appended claims and their equivalents.

What is claimed is:

1. An image forming apparatus connectable to a network and provided with the number of printable sheets set for each user, comprising:
a determination unit determining whether or not there is a print instruction exceeding the number of printable sheets set for the user;
a retrieval unit retrieving an image forming apparatus available for the user from among other image forming apparatuses connected to the network when the determination unit determines that there is the print instruction exceeding the number of printable sheets set for the user; and
a data output unit outputting data of an image which should have been printed on the basis of the print instruction from the user when the retrieval unit detects any image forming apparatus available for the user.

2. The image forming apparatus according to claim 1, further comprising a printed sheet counter unit counting the number of sheets printed on the basis of the print instruction from the user.

3. An image forming apparatus connectable to a network and provided with the number of printable sheets set for each user, comprising:
a printed sheet counter unit counting the number of sheets printed on the basis of a print instruction from the user;
a retrieval unit retrieving an image forming apparatus available for the user from among other image forming apparatuses connected to the network after a count of the printed sheet counter unit reaches the number of printable sheets set for the user when the print instruction from the user is received; and
a data output unit outputting data of an image which should have been printed on the basis of the print instruction from the user when the retrieval unit detects any image forming apparatus available for the user.

4. The image forming apparatus according to claim 2, comprising a data input section inputting image data output from the data output units of the other image forming apparatus connected to the network, wherein
the printed sheet counter unit also counts the number of sheets to be printed on the basis of the image data input by the data input section.

5. The image forming apparatus according to claim 1, comprising a connection port to which a storage medium is connectable, wherein
the data output unit outputs the data of the image to the storage medium connected to the connection port.

6. The image forming apparatus according to claim 1, wherein
the data output unit outputs information on the number of sheets to be printed on the basis of the print instruction from the user, in addition to the data of the image.

7. The image forming apparatus according to claim 1, wherein
the data output unit outputs the data of the image as bitmap data.

8. The image forming apparatus according to claim 1, comprising an information unit giving information on the found image forming apparatus when the retrieval unit finds the image forming apparatus.

9. The image forming apparatus according to claim 1, comprising a setting unit setting an image forming apparatus to be used by the user from among a plurality of the found image forming apparatuses when the retrieval unit finds the plurality of image forming apparatuses.

10. An image forming system constructed by connecting to a network a plurality of image forming apparatuses each provided with the number of printable sheets set for each user, wherein
each of the image forming apparatuses comprises:
a determination unit determining whether or not there is a print instruction exceeding the number of printable sheets set for the user;
a retrieval unit retrieving an image forming apparatus available for the user from among other image forming apparatuses connected to the network when the determination unit determines that there is the print instruction exceeding the number of printable sheets set for the user;
a transfer unit transferring data of an image which should have been printed on the basis of the print instruction from the user when the retrieval unit detects any image forming apparatus available for the user, to the image forming apparatus detected by the retrieval unit; and
a printable sheet number update unit subtracting the number of printed sheets from the number of printable sheets set for the user when receiving the data of the image from the other image forming apparatus and forming the image which should have been printed on the basis of the print instruction from the user.

11. An image forming apparatus connectable to a network and provided with the number of printable sheets set for each user, comprising:
a determination means determining whether or not there is a print instruction exceeding the number of printable sheets set for the user;
a retrieval means retrieving an image forming apparatus available for the user from among other image forming apparatuses connected to the network when the determination means determines that there is the print instruction exceeding the number of printable sheets set for the user; and
a data output means outputting data of an image which should have been printed on the basis of the print instruction from the user when the retrieval means detects any image forming apparatus available for the user.

12. The image forming apparatus according to claim 11, further comprising a printed sheet counter means counting the number of sheets printed on the basis of the print instruction from the user.

13. An image forming apparatus connectable to a network and provided with the number of printable sheets set for each user, comprising:
a printed sheet counter means counting the number of sheets printed on the basis of a print instruction from the user;
a retrieval means retrieving an image forming apparatus available for the user from among other image forming apparatuses connected to the network after a count of the printed sheet counter means reaches the number of printable sheets set for the user when the print instruction from the user is received; and
a data output means outputting data of an image which should have been printed on the basis of the print instruction from the user when the retrieval means detects any image forming apparatus available for the user.

14. The image forming apparatus according to claim 12, comprising a data input section inputting image data output from the data output means of the other image forming apparatus connected to the network, wherein
the printed sheet counter means also counts the number of sheets to be printed on the basis of the image data input by the data input section.

15. The image forming apparatus according to claim 11, comprising a connection port to which a storage medium is connectable, wherein
the data output means outputs the data of the image to the storage medium connected to the connection port.

16. The image forming apparatus according to claim 11, wherein
the data output means outputs information on the number of sheets to be printed on the basis of the print instruction from the user, in addition to the data of the image.

17. The image forming apparatus according to claim 11, wherein
the data output means outputs the data of the image as bitmap data.

18. The image forming apparatus according to claim 11, comprising an information means giving information on the found image forming apparatus when the retrieval means finds the image forming apparatus.

19. The image forming apparatus according to claim 11, comprising a setting means setting an image forming apparatus to be used by the user from among a plurality of the found image forming apparatuses when the retrieval means finds the plurality of image forming apparatuses.

20. An image forming system constructed by connecting to a network a plurality of image forming apparatuses each provided with the number of printable sheets set for each user, wherein
each of the image forming apparatuses comprises:
a determination means determining whether or not there is a print instruction exceeding the number of printable sheets set for the user;
a retrieval means retrieving an image forming apparatus available for the user from among other image forming apparatuses connected to the network when the determination means determines that there is the print instruction exceeding the number of printable sheets set for the user;
a transfer means transferring data of an image which should have been printed on the basis of the print instruction from the user when the retrieval means detects any image forming apparatus available for the user, to the image forming apparatus detected by the retrieval means; and
a printable sheet number update means subtracting the number of printed sheets from the number of printable sheets set for the user when receiving the data of the image from the other image forming apparatus and forming the image which should have been printed on the basis of the print instruction from the user.
